(19) United States
(12) Patent Application Publication
(10) Pub. No.: US 2024/0318336 A1
(43) Pub. Date: Sep. 26, 2024

(54) METHOD FOR CONTROLLONG AN ELECTROLYZER ARRANGEMENT HAVING AT LEAST TWO ELECTROLYZERS FOR OPTIMIZED BALANCE OF PLANT

(71) Applicant: SUZLON ENERGY LIMITED, Gujarat (IN)

(72) Inventor: Nitin AHIRE, Dist-Nashik (IN)

(73) Assignee: SUZLON ENERGY LIMITED, Gujarat (IN)

(21) Appl. No.: 18/609,438

(22) Filed: Mar. 19, 2024

(30) Foreign Application Priority Data
Mar. 23, 2023 (IN) 202321020421

(51) Int. Cl. C25B 15/02; C25B 1/02

(52) U.S. Cl. CPC C25B 15/02; C25B 1/02

(57) ABSTRACT

A method for controlling an electrolyzer arrangement having at least two electrolyzers for optimized balance of plant, comprising obtaining electrical power provided by an electrical power source, obtaining required electrical power of power plant and determining available power for hydrogen production based on provided electrical power and required electrical power, determining an upper and lower operating limit of a primary electrolyzer of the electrolyzer arrangement and controlling the primary electrolyzer and at least one secondary electrolyzer depending on the available electrical power and operating limit of the primary electrolyzer.

This application claims the benefit of priority of Indian patent application 202321020421, filed 23^{th} of Mar. 2023, the entire contents of which are incorporated herein by reference.

### FIELD OF INVENTION

The present invention is directed to a method for controlling an electrolyzer arrangement, an electrolyzer arrangement for the same and a power plant having said electrolyzer arrangement.

### BACKGROUND

In prior art several systems of renewable energy power plants combined with hydrogen production plants are known as well as several control schemes for controlling the input power and system operation control are also known.

One example is EP 3 957 773 A1, which discloses an energy composite hydrogen production system and a control method therefore. The energy composite hydrogen production system comprises: an energy power generation system, a power conversion system, an alkali liquid hydrogen production system, and a non-alkali liquid hydrogen production system. An output end of the power conversion system is connected to an input electrode of the alkali liquid hydrogen production system and an input electrode of the non-alkali liquid hydrogen production system, respectively, so that the power conversion system can, according to the quantity of energy outputted by the energy power generation system, choose to provide hydrogen production energy to the alkali liquid hydrogen production system or the non-alkali liquid hydrogen production system. Furthermore, the non-alkali liquid hydrogen production system can replace battery energy storage so as to implement energy reception in a weak energy region, thereby avoiding the waste of energy and improving the economic benefits of hydrogen production.

Further prior art is IN 8992/DELNP/2012 A which discloses a nested configuration of electrolysis units, independently operated, the power output values of which are descendant in such a manner that, for any unit of the system, the sum of the power output values of the smaller electrolysis units is always greater than or equal to the “dead band” (DB) of said units, allowing reduction of the dead band of said hydrogen production system to negligible levels, avoiding loss or discharge of the energy generated in said renewable power stations, preferably one or several wind farms formed by a group of wind turbines, connected to the power grid as a consequence of the implementation of a primary control service therein or, in general, of any other active power control service, thereby optimizing the total energy obtained.

Further prior art is EP 4 057 476 A2 which discloses a system for producing hydrogen from renewable energy and a control method thereof. The system includes a renewable-energy-based power generation system, a primary hydrogen production system, a secondary hydrogen production system, and a controller. An output end of the renewable-energy-based power generation system is connected to the primary hydrogen production system and the secondary hydrogen production system via an electrical conversion device. A capacity of the primary hydrogen production system is greater than or equal to a capacity of the secondary hydrogen production system. The controller is configured to monitor an output electrical performance parameter of the renewable-energy-based power generation system in real time, and control turn on and turn off of the primary hydrogen production system and the secondary hydrogen production system.

The prior art fails to address the system power management, operation and control strategy within the hybrid system configuration with variable power sources. Furthermore; the balance of plant system operation standby mode/part load operation/full load operation will have different operating and control strategies which the prior art fails to provide.

### OBJECT OF THE INVENTION

One object of the present invention is to provide a method for controlling an electrolyzer arrangement with two or more electrolyzers of same or different technologies. Another object of the invention is to provide flexible operation modes for maximum capacity or maximum efficiency using the hybrid electrolyzer arrangement.

### SUMMARY OF THE INVENTION

This object will be solved by a method for controlling an electrolyzer arrangement having at least two electrolyzers for optimized plant operation. In particular the electrolyzer arrangement comprises of two or more electrolyzers of similar or different technologies. The method comprises the steps of obtaining electrical power provided by an electrical power source, obtaining required electrical power of power plant and determining available power for hydrogen production based on provided electrical power and required electrical power, wherein determining an upper and lower operating limit of a primary electrolyzer of the electrolyzer arrangement and controlling the primary and at least one secondary electrolyzer depending on the available electrical power and operating limit of the primary electrolyzer and secondary electrolyzer.

Advantageously, the electrolyzer arrangement can be for example a combination of alkaline electrolyzer (ALK) and alkaline electrolyzer with different sizes; polymer electrolyte membrane electrolyzer (PEM) and alkaline electrolyzer or alkaline electrolyzer and polymer electrolyte membrane electrolyzer and solid oxide electrolyzer (SOEC). These electrolyzers are sized to meet the hydrogen production requirement while maintaining low level of cost of hydrogen.

More advantageously, an electrical power source can be a wind power plant, solar power plant, hydro power plant or energy storage system or a combination thereof.

According to a preferred embodiment, the method further comprises the step of starting the primary electrolyzer if available electrical power is between upper and lower operating limit of the primary electrolyzer and the secondary electrolyzer is in standby mode.

Advantageously, in this case the secondary electrolyzer is in standby mode. In this mode, the secondary electrolyzer consume minimum power to keep the electrolyzer in warm state so that it can quickly start it's operation when the power is sufficient to initiate it's operation.

According to a preferred embodiment, the method further comprises the step of starting the at least one secondary electrolyzer if the available electrical power is less than the lower operating limit of the primary electrolyzer, wherein the primary electrolyzer is in standby mode.

Advantageously, in this case the primary electrolyzer is in standby mode. In this mode, the primary electrolyzer consume minimum power to keep the electrolyzer in warm state so that it can quickly start it's operation when the power is sufficient to initiate it's operation. Advantageously minimum available electrical power can be used for hydrogen production via the at least one secondary electrolyzer.

According to a preferred embodiment, the method further comprises the step of starting the at least one secondary electrolyzer and primary electrolyzer if the available electrical power is higher than the upper operating limit of the primary electrolyzer.

According to a preferred embodiment, the method further comprises the step of operating at least one secondary electrolyzer and primary electrolyzer, if the available electrical power is between maximal operation point of the upper operating limit of the electrolyzer arrangement and maximal operation point of the upper operating limit of the primary electrolyzer then the electrolyzer arrangement provides maximum hydrogen production efficiency.

According to a preferred embodiment, the method further comprises the step of operating at least one secondary electrolyzer and primary electrolyzer, if the available electrical power is at maximal operating point of the upper operating limit of the electrolyzer arrangement and is at maximal operation point of the upper operating limit of the primary electrolyzer then the electrolyzer arrangement provides maximum hydrogen production rate.

In particular, with this configuration the optimal load and most efficient point is reached. The at least one secondary electrolyzer provides additional capacity to the primary electrolyzer and primary electrolyzer operates at operating point lower than maximum operating point and is at maximum hydrogen production efficiency. Advantageously, overpower of primary electrolyzer can be used for hydrogen production via the at least one secondary electrolyzer. In this context, starting has no restrictive meaning in sense of the respective electrolyzer starts from a non-operating point. It is clear that during the operation the available power can change and the electrolyzers can switch from standby mode to operation mode and vice versa. Especially in case the available power reaches the upper operational limit of the primary electrolyzer the at least one secondary electrolyzer will switch from standby mode to operation mode for providing additional capacity while the primary electrolyzer stays in operation mode,

According to a preferred embodiment, the method further comprises that the primary electrolyzer is characterized by a slow response time, e.g. in minutes and or limited low operating point and is higher in capacity and the at least one secondary electrolyzer is characterized by a fast response time, e.g. in seconds or similar response time and not limited by low operating point and is small in capacity.

Advantageously, the primary electrolyzer is a slow responding type of electrolyzer and the at least one secondary electrolyzer is a fast responding type of electrolyzer. In a more preferred embodiment the electrolyzer arrangement comprises an alkaline electrolyzer sized up to multi megawatt scale as primary electrolyzer and at least one polymer electrolyte membrane electrolyzer sized in kilowatt scale as secondary electrolyzer.

According to a preferred embodiment, the method further comprises that the upper and lower operating limit of electrolyzers depending on the balance of plant power requirement of the electrolyzers.

A further aspect of the invention is directed to an electrolyzer arrangement for producing hydrogen.

The electrolyzer arrangement for producing hydrogen comprising at least two electrolyzers, wherein the electrolyzer arrangement comprise a primary electrolyzer and at least one secondary electrolyzer, connected to a controller configured to executing said method mentioned above.

Advantageously, the electrolyzer arrangement can be for example a combination of alkaline electrolyzer (ALK) and alkaline electrolyzer with different sizes; polymer electrolyte membrane electrolyzer (PEM) and alkaline electrolyzer or alkaline electrolyzer and polymer electrolyte membrane electrolyzer and solid oxide electrolyzer (SOEC). Size and count of the electrolyzers of the electrolyzer arrangement depends on the provided electrical power by the power source. The higher the provided available electrical power the higher can be the size and count of the electrolyzers of the electrolyzer arrangement.

A further aspect of the present invention is directed to a power plant for producing electrical power and hydrogen.

The power plant for producing electrical power and hydrogen comprising at least one wind turbine or at least one solar power plant or at least one hydro power plant or at least one energy storage device or combination thereof, characterized by said electrolyzer arrangement mentioned above.

Advantageously, the power plant comprises of common water treatment & power distribution unit which regulates the input power as well as water required for the electrolyzer arrangement. Further the balance of plant components for the electrolyzer arrangement comprises a gas separation, purification equipment, thermal management to handle the requirements of both primary as well as secondary electrolyzers.

A further aspect of the present invention is directed to a method for operating said power plant.

A further aspect of the present invention is directed to a computer program product.

The computer program product comprises instructions which, when the program is executed by a computer, cause the computer to carry out the steps of said method mentioned above.

Advantages of the present invention are:
Efficient integration of electrolyzers and their balance of power,
Lowering the cost of hydrogen generation since electrolyzers can be operated at maximum efficient point,
Lowering the degradation of the alkaline electrolyzer by limiting the cold start/stop cycles and last but not least
Maximum utilization of electrolyzers to monetization of investment.

### BRIEF DESCRIPTION OF DRAWINGS

The invention will now be explained in more detail with respect to exemplary embodiments with reference to the enclosed drawings, wherein:

FIG. 1 shows a power plant for producing electrical power and hydrogen;

FIG. 2 shows a flow diagram of the method for controlling an electrolyzer arrangement;

FIG. 3 shows a capacity-power-diagram and

FIG. 4 shows an efficiency-power-diagram.

The foregoing and other aspects will become apparent from the following detailed description of the invention when considered in conjunction with the accompanying drawing figures.

### DETAILED DESCRIPTION OF THE INVENTION

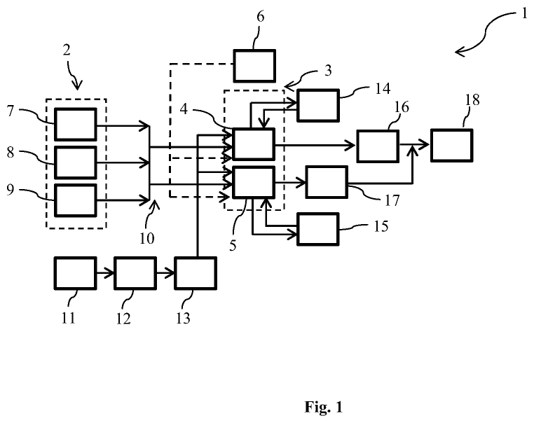

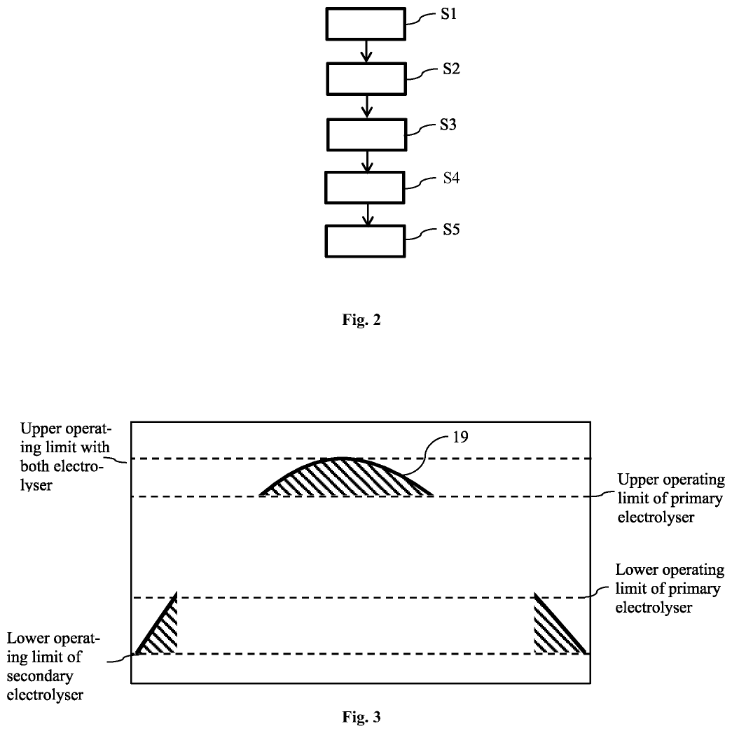

FIG. 1 depicts a power plant 1 having a power source 2 for providing electrical power to an electrolyzer arrangement 3. Latter comprising at least two electrolyzers, wherein one electrolyzer configured as primary electrolyzer 5 and at least one electrolyzer configured as secondary electrolyzer 4. Even if FIG. 1 and in the following description refers to one secondary electrolyzer 4, the present invention also covers more than one secondary electrolyzer 4. The primary electrolyzer 5 may have a slow response time, e.g. in minutes and can be operate at it's limited lower operating point, wherein the secondary electrolyzer 4 may have a fast response time, e.g. in seconds and can be operated at low power load of the power supply arrangement. For example the primary electrolyzer 5 is an alkaline electrolyzer having a multi kilowatt up to multi megawatt scale. And for example the secondary electrolyzer 4 is a polymer electrolyte membrane electrolyzer having a kilowatt scale. The primary electrolyzer 5 and secondary electrolyzer 4 are controlled by a controller 6. The control method will be explained later with FIG. 2.

The power source 2 comprises a hybrid renewable power arrangement comprising of solar power plant 7, a wind power plant 8 and a hydro power plant 9. The solar power plant 7 comprises at least one solar panel and the wind power plant 8 comprises at least one wind turbine. In consequence the power source 2 provides electrical power from renewable power sources with natural fluctuations, natural daily pattern and seasonal variations. Such fluctuations and pattern can be handled by the electrolyzer arrangement 3 according to the present invention, which will be explained later. The electrolyzer arrangement 3 and remaining balance of plant components of the electrolyzer arrangement 3 receives electrical power from the power source 2. The electrolyzer arrangement 3 receives the electrical power through a power management circuit 10. Further the power source 2 can optionally comprising of an energy storage device (not shown in FIG. 1). The energy storage device can comprise one or more energy storage known in prior art.

Further the power plant 1 comprises a water supply device 11 for providing water for hydrogen production. This water can be provided by tanks, pipelines and/or natural water sources like river or sea. From the water supply device 11, water will be provided to a water purification device 12 for cleaning the water from particulates, salts and other contaminations. The purified water will be stored in a purified water storage device 13. The purified water will be transferred to the primary electrolyzer 5 and to the secondary electrolyzer 4 with the help of flow control arrangement (not shown) so that electrolyzer operation can be handled independently or together depending upon the need. Further a water re-circulation loop consists of polishing system to purify re-circulating water (not shown in FIG. 1). Each of the electrolyzers 4, 5 is connected to a cooling system 14, 15. The cooling systems 14, 15 make sure that the electrolyzers 4, 5 working under optimal conditions especially under optimal temperature conditions, which depend on the electrolyzer in operation. The hydrogen output of the secondary electrolyzer 4 is fed to a gas purification module 16. The hydrogen output of the secondary electrolyzer 4 may have purity of more or equal to 98% and pressure more or equal to 1 barg, or more or equal to 15 barg or more or equal to 30 barg. The hydrogen output of the primary electrolyzer 5 is fed to a gas purification system 17. The purified hydrogen will be transported from the gas purification system 17 to the hydrogen storage device 18. The hydrogen will be transported to an application and/or consumer from the hydrogen storage device 18. As hydrogen storage device 18 can be used any type of storage known in prior art like compressed hydrogen, liquefied hydrogen, organic hydrogen carriers, physical storage and/or chemical storage. Alternative or additional the hydrogen can be used for producing ammonia or other chemicals. The primary electrolyzer 5 and secondary electrolyzer 4 will have independent gas purification system 17 in order to handle the limiting load operation.

The controller 6 controls and manages the input power and provides regulated power to the primary electrolyzer 5 and secondary electrolyzer 4, which is indicated by dashed line. When the power source 2 provides low electrical power like between 5-30% of nominal load required for primary electrolyzer 5, the controller 6 configured so that the electrical power will be provided to the secondary electrolyzer 4 while the primary electrolyzer 5 is maintained in standby mode. In this mode, the primary electrolyzer 5 consume minimum power like between 1-5% of nominal electrical capacity, to keep it in warm state so that it can quickly start it's operation when the power is sufficient to initiate it's operation. If the electrical power is in a sufficient range then the primary electrolyzer 5 will be activated and the secondary electrolyzer 4 will be in standby mode. When more electrical power available is than from the primary electrolyzer 5 is required, both the primary electrolyzer 5 and the secondary electrolyzer 4 operate to produce maximum amount of hydrogen. In another scenario, when more power is available both the electrolyzer 4, 5 operates at highest efficiency point i.e. less than 100% capacity factor e.g. 80-90% capacity point and varies from one technology to another. In this case there is no need to curtail the extra electrical power from the power source 2. The additional electrical power can be diverted to energy storage device (not shown) while maintaining electrolyzer arrangement 3 operation at highest efficiency point. The secondary electrolyzer 4 is used in two scenarios; when input electrical power available is less than lower operating limit of the primary electrolyzer 5 and additional electrical power is available more than the primary electrolyzer 5 requirements beyond maximum efficiency point. The controller 6 maybe is implemented in a park controller of the power plant (if available).

In a not shown embodiment the power plant 1 can comprise more than one electrolyzer arrangement 3. These electrolyzer arrangements can be controlled by an individual controller or by a central controller.

In following the method for controlling an electrolyzer arrangement 3 will be explained with help of FIG. 2. The method for controlling the electrolyzer arrangement 3 having at least two electrolyzers 4, 5 for optimized balance of plant; the method comprises at least the steps of S1 to S5. The electrolyzer arrangement 3 comprises a primary electrolyzer 5 and a secondary electrolyzer 4 as described above.

Step S1 comprises obtaining available electrical power provided by the power source 2. This data will be provided to the controller 6. To obtain the electrical power several methods are possible, for example measuring output power from the power source 2, in particular from the solar power plant 7, wind power plant 8 and hydro power plant 9 via a measuring device not shown. Another example can be that the plant controller of the respective power plants 7, 8, 9 maybe determine the electrical power output and send the data to the controller 6. Or any other suitable method is possible. Available power check will be done continuously during the operation.

Step S2 comprises obtaining a required electrical power of the electrolyzer arrangement 3. The required electrical power for the primary electrolyzer 5 and secondary electrolyzers 4 determined by excluding the power required for the auxiliaries of the power plant 1. This covers all required power of the primary electrolyzer 5 and secondary electrolyzer 4 for standby mode and operation mode. Depending on this as well as the size and count of the respective electrolyzers have influence of the required power. It is also possible that the remaining electrical power consuming components of the power plant 1 will be considered for determining the required electrical power. In this case also the consumed power of water supply device 11, water purification device 12, purified water storage device 13, cooling system 14, 15, gas purification module 16, gas purification system 17 and hydrogen storage/consumer 18 can be considered.

Step S3 comprises determining available power for hydrogen production based on provided electrical power and required electrical power. The available power for hydrogen production is the result of the difference between provided electrical power of step S1 and required electrical power of step S2.

Step S4 comprises of determining power consumption from a pre-defined upper and lower operating limit of the primary electrolyzer 5 of the electrolyzer arrangement 3. In particular, the upper and lower operating limit of the primary electrolyzer 5 depends on the stack operating limits and the balance of plant operating limits of the primary electrolyzer 5.

Step S5 comprises controlling the primary electrolyzer 5 and the secondary electrolyzer 4 via the controller 6 depending on the available electrical power and determined operating limits of the primary electrolyzer 5. The individual primary electrolyzer 5 and secondary electrolyzer 4 will be switched from operation mode to standby mode and vice-versa depending on current available electrical power. Therefore the following configurations are possible:
starting the primary electrolyzer 5 if available electrical power is between upper and lower operating limit of the primary electrolyzer 5, wherein the secondary electrolyzer 4 is in standby mode (Scenario 1);
starting the secondary electrolyzer 4 if the available electrical power is less than the lower operating limit of the primary electrolyzer 5, wherein the primary electrolyzer 5 is in standby mode (Scenario 2);
starting the secondary electrolyzer 4 if the available electrical power is higher than the upper operating limit of the primary electrolyzer 5, wherein the primary electrolyzer 5 is in operation mode (Scenario 3).

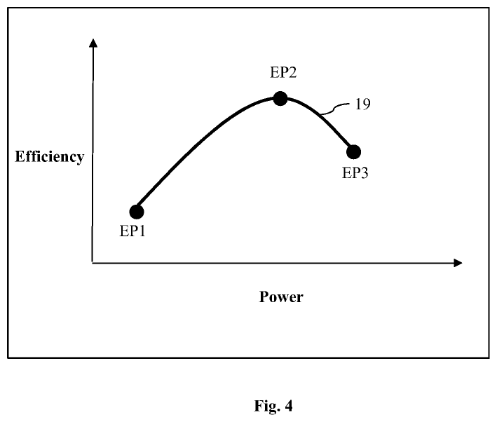

In scenario 3 both the secondary electrolyzer 4 and primary electrolyzer 5 are in operation mode. This means that the upper operating limit of the secondary electrolyzer 4 and upper operating limit of the primary electrolyzer 5 cumulating to the upper operating limit of the electrolyzer arrangement 3 (see FIG. 3). In case the available electrical power is between maximal operation point of the upper operating limit of the electrolyzer arrangement 3 and maximal operation point of upper operating limit of the primary electrolyzer 5, the secondary electrolyzer 4 and primary electrolyzer 5 operating at maximum hydrogen production efficiency. Further in case the available electrical power is at maximal operating point of the upper operating limit of the electrolyzer arrangement 3 and is at maximal operation point of the upper operating limit of the primary electrolyzer 5, the secondary electrolyzer 4 and primary electrolyzer 5 operating at maximum hydrogen production rate.

FIG. 3 depicts a capacity-power-diagram with an available power curve 19. As can be seen if the available power is below the lower operating limit of the primary electrolyzer 5 the secondary electrolyzer 4 is in operation mode in which hydrogen will be produced. At the same time the primary electrolyzer 5 is in standby mode in which no hydrogen will be produced, but in standby mode the primary electrolyzer 5 consume minimum power to keep the primary electrolyzer 5 in warm state so that it can quickly start it's operation when the available power is sufficient to initiate it's operation. This happens when the available power increase and reaches the lower operating limit of the primary electrolyzer 5. So the primary electrolyzer 5 switches from standby mode to operation mode to produce hydrogen. If the available power is between the lower and upper operating limit of the primary electrolyzer 5 the secondary electrolyzer 4 switches form operation mode to standby mode in which no hydrogen will be produced, but in standby mode the secondary electrolyzer 4 consumes minimum power to keep the secondary electrolyzer 4 in warm state so that it can quickly start its operation when the available power is sufficient to initiate it's operation. If the available power increases further and reaches the upper operating limit of the primary electrolyzer 5 then the secondary electrolyzer 4 switches from standby mode to operation mode. At this stage both the primary electrolyzer 5 and the secondary electrolyzer 4 are in operation mode and each produce hydrogen with most efficiency. Now the electrolyzer arrangement 3 has maximum capacity for hydrogen production at an upper operating limit with of both the primary electrolyzer 5 and the secondary electrolyzer 4.

FIG. 3 shows an upper operating limit of the electrolyzer arrangement 3. This is the sum of the upper operating limit of the secondary electrolyzer 4 and upper operating limit of the primary electrolyzer 5. Therefor the secondary electrolyzer 4 and primary electrolyzer 5 are in operation mode. In case the available electrical power is between maximal operation point of the upper operating limit of the electrolyzer arrangement 3 and maximal operation point of upper operating limit of the primary electrolyzer 5, the secondary electrolyzer 4 and primary electrolyzer 5 operating at maximum hydrogen production efficiency. Further in case the available electrical power is at maximal operating point of the upper operating limit of the electrolyzer arrangement 3 and is at maximal operation point of the upper operating limit of the primary electrolyzer 5, the secondary electrolyzer 4 and primary electrolyzer 5 operating at maximum hydrogen production rate.

If the available electrical power decreasing below the upper operating limit of the primary electrolyzer 5 then the secondary electrolyzer 4 switches from operation mode in standby mode. Also here in case that the available electrical power is between the upper and lower operating limit of the primary electrolyzer 5, it will stay in operation mode until the available electrical power falls below the lower operating limit of the primary electrolyzer 5. If the available electrical power falls below the lower operating limit of the primary electrolyzer 5 then the primary electrolyzer 5 switches from operation mode to standby mode. At the same time the secondary electrolyzer 4 switches from standby mode to operation mode.

This shows that over a wide bandwidth of available power the electrolyzer arrangement 3 can produce hydrogen with highest efficiency because of using all available electrical power and all electrolyzers working at optimal operation conditions. This optimal operation may help in reducing the production costs of hydrogen.

FIG. 4 depicts an efficiency-power-diagram. This shows different efficiency points EP over an available electrical power curve 19. At EP1 only primary electrolyzer 5 is in operation mode but at lower operating point, wherein secondary electrolyzer 4 is in standby mode. At EP2 both the secondary electrolyzer 4 and primary electrolyzer 5 are in operation mode. At this point the highest efficiency is reached. At EP3 only the primary electrolyzer 5 is in operation mode, wherein the secondary electrolyzer 4 is in standby mode or operation mode. As can be seen from FIG. 4 the secondary electrolyzer 4 has the fast response time—means a quick switch from standby mode to operation mode and vice versa—the secondary electrolyzer 4 can react very fast according to the changes in available electrical power. The primary electrolyzer 5 has the slow response time-means a slow switch from standby mode to operation mode and vice versa—the primary electrolyzer 5 reacts slowly to the fluctuations in available electrical power. This can be compensated by the secondary electrolyzer 4, with described method above. In result there is a synergy effect of primary electrolyzer 5 and secondary electrolyzer 4 that according to the available electrical power hydrogen can be produced with highest efficiency or at maximum production rate.

### LIST OF REFERENCE SIGNS

1 power plant
2 power source
3 electrolyzer arrangement
4 secondary electrolyzer
primary electrolyzer
6 controller
7 solar power plant
8 wind power plant
9 hydro power plant
power management circuit
11 water supply device
12 water purification device
13 purified water storage device
14 cooling system-1
15 cooling system-2
16 gas purification module
17 gas purification system
18 hydrogen storage/consumer
19 available power curve

We claim:

1. A method for controlling an electrolyzer arrangement having at least two electrolyzers for optimized balance of plant, the method comprises the steps of:
obtaining electrical power provided by an electrical power source,
obtaining required electrical power of power plant and
determining available power for hydrogen production based on provided electrical power and required electrical power,
wherein
determining an upper and lower operating limit of a primary electrolyzer of the electrolyzer arrangement and
controlling the primary electrolyzer and at least one secondary electrolyzer depending on the available electrical power and operating limit of the primary electrolyzer.

2. The method for controlling an electrolyzer arrangement according to claim 1, wherein starting the primary electrolyzer if available electrical power is between upper and lower operating limit of the primary electrolyzer, wherein the at least one secondary electrolyzer is in standby mode.

3. The method for controlling an electrolyzer arrangement according to claim 1, wherein starting the at least one secondary electrolyzer if the available electrical power is less than the lower operating limit of the primary electrolyzer, wherein the primary electrolyzer is in standby mode.

4. The method for controlling an electrolyzer arrangement according to claim 1, wherein starting the at least one secondary electrolyzer and the primary electrolyzer if the available electrical power is higher than the upper operating limit of the primary electrolyzer.

5. The method for controlling an electrolyzer arrangement according to claim 4, wherein operating at least one secondary electrolyzer and primary electrolyzer, if the available electrical power is between maximal operation point of the upper operating limit of the electrolyzer arrangement and maximal operation point of the upper operating limit of the primary electrolyzer then the electrolyzer arrangement provides maximum hydrogen production efficiency.

6. The method for controlling an electrolyzer arrangement according to claim 4, wherein operating at least one secondary electrolyzer and primary electrolyzer, if the available electrical power is at maximal operating point of the upper operating limit of the electrolyzer arrangement and is at maximal operation point of the upper operating limit of the primary electrolyzer then the electrolyzer arrangement provides maximum hydrogen production.

7. The method for controlling an electrolyzer arrangement according to claim 1, wherein the primary electrolyzer is a slow response time and is with higher in capacity and the at least one secondary electrolyzer is a fast response time.

8. The method for controlling an electrolyzer arrangement according to claim 1, wherein the upper and lower operating limit of a primary electrolyzer depending on the balance of power of the primary electrolyzer.

9. An electrolyzer arrangement for producing hydrogen comprising at least two electrolyzers wherein the least two electrolyzers comprises a primary electrolyzer and at least one secondary electrolyzer, connected to a controller configured for executing a method according to claim 1.

10. A power plant for producing electrical power and hydrogen comprising at least one wind power plant or at least one solar power plant or at least one hydro power plant or at least one energy storage device or combination thereof, further comprising an electrolyzer arrangement according to claim 9.
